(19) United States
(12) Patent Application Publication
(10) Pub. No.: US 2002/0046715 A1
(43) Pub. Date: Apr. 25, 2002

(54) Anti-shedding pet collar

(76) Inventor: Mary B. McCarville, Toronto (CA)

Correspondence Address: Stephen M. Beney, Bereskin & Parr, 40 King Street West, Box 401, Toronto, ON, M5H 3Y2, CA

(21) Appl. No.: 09/981,755

(22) Filed: Oct. 19, 2001

Related U.S. Application Data
(60) Provisional application No. 60/241,355, filed on Oct. 19, 2000.

(51) Int. Cl. A62B 35/00

(52) U.S. Cl. 119/858

(57) ABSTRACT

This invention provides an apparatus for reducing shedding in pets the apparatus comprising: a collar of a suitable length to fit around the neck of a pet; and at least one magnet fitted on the collar. Each of the magnets has a north pole directed towards the neck of the pet, and each of the magnets has a magnetic field strength in the range of 500 to 1000 gauss.

### FIELD OF THE INVENTION

The present invention relates to an apparatus and its use to reduce shedding in some pets such as dogs and cats.

### BACKGROUND OF THE INVENTION

It is well known that most breeds of dogs and cats are prone to shedding. When such breeds are kept as pets inside a home, cleaning up the hairs shed by the animals can become a tiresome chore for the pet owner. While regular coat brushing and grooming of the household pet is often recommended as a way to reduce shedding around the home, the brushing itself can become a tedious chore for the pet owner. Therefore, it is worthwhile to explore alternative ways to reduce shedding in household pets such that the requirement for cleaning the home and brushing and grooming the pet is reduced.

### SUMMARY OF THE INVENTION

The present inventor has designed an apparatus and discovered a new use of a material which is believed to reduce shedding in some pets such as dogs and cats. The material in question is a magnet, and the apparatus is a means for positioning the magnet or magnets in close proximity to the pet.

Through tests conducted by the inventor using an embodiment of the present invention, it has been discovered that applying a magnetic field to a pet may reduce the level of shedding by the pet. This has also revealed that the orientation and strength of the magnets used and the point of application of the magnets promote the desired effect of reducing the level of shedding by a pet. Also, a balanced distribution of the magnets is believed to promote the desired effect.

In a first aspect of the present invention, there is provided an apparatus for reducing shedding in pets. The apparatus comprises a collar of a suitable length to fit around the neck of a pet and at least one magnet fitted on the collar. Each magnet has its north pole directed towards the neck of the pet. Further, the magnetic field produced is sufficient to reduce shedding in pets. Preferably, the magnetic field strength for each magnet is in the range of 500 to 1000 gauss.

In one embodiment of the invention, the collar comprises a length of an outer strap, and a length of a padded layer provided on one side of the outer strap and forming an inner surface of the collar. Each magnet is fitted between the outer strap and the padded layer.

In another embodiment, a plurality of magnets are distributed at intervals along the length of the collar.

In another embodiment, there are three magnets, with the magnets distributed at intervals along the collar to form a triangle when the collar is worn around the neck of a pet.

In yet another embodiment, the outer strap comprises a nylon strap and the padded layer is one of felt and cotton. The outer strap can also be made from leather or a combination of suitable materials, such as, for example, leather and nylon.

In another embodiment, the outer strap and the padded layer are fastened together by stitching, and each of the magnets is retained in position by stitching.

The collar may be length-adjustable and may include a releasable fastener adapted to releasably fasten each end of the collar to, for example, each other.

More conveniently, the releasable fastener may comprise a two-piece interlocking plastic buckle with at least one of the pieces being adapted to slidably receive one looped end of the collar. The loop can be adjustable in size to facilitate the length-adjustment of the collar.

In another aspect of the present invention, there is provided a use of a magnetic field to reduce shedding in a pet. The pet is typically a dog or a cat. The magnetic field is provided by positioning at least one magnet around the neck of the pet. Each magnet has its north pole oriented towards the neck of the pet. The magnetic field is sufficient to reduce shedding in pets. Preferably each magnet has a strength in the range of 500 to 1000 gauss.

### BRIEF DESCRIPTION OF THE DRAWINGS

For a better understanding of the present invention, and to show more clearly how it may be carried into effect, reference will now be made, by way of example, to the accompanying drawings which show a preferred embodiment of the present invention.

FIG. 1 shows a perspective view of a preferred embodiment of a collar according to the present invention;

FIG. 2 shows a top view of the preferred embodiment of FIG. 1; and

FIG. 3 shows a corresponding bottom view of the preferred embodiment of FIG. 1.

### DETAILED DESCRIPTION OF THE INVENTION

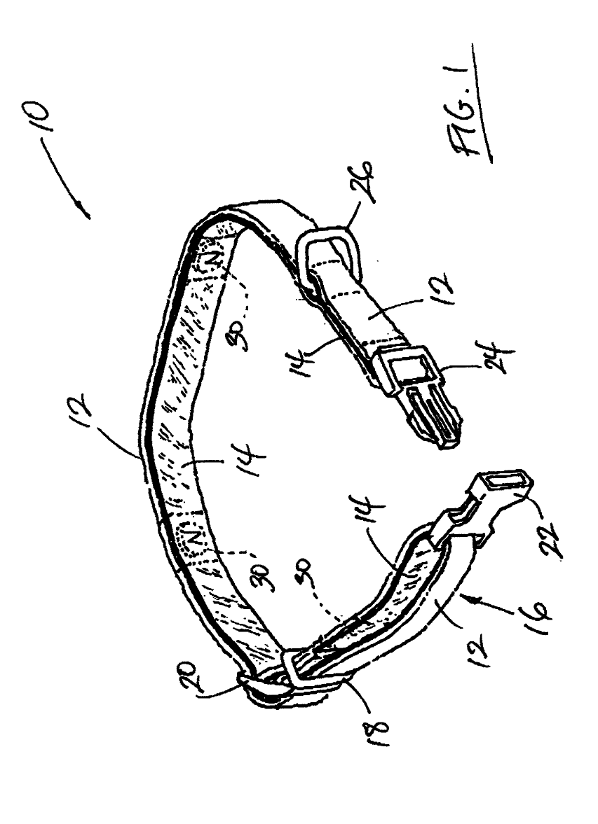

Referring to FIGS. 1-3, a preferred embodiment of a pet collar is generally indicated by reference numeral 10. As shown, the collar 10 has a number of magnets 30 fitted into the collar 10 at intervals along the length of the collar 10. As shown, all of the magnets 30 have a north pole facing the inside of the collar 10 (shown in FIG. 3) so that the north poles of the magnets 30 are directed towards the neck of the pet when the collar 10 is worn by the pet. The pet is typically a dog or a cat.

The magnets 30 are preferably of high strength, in the range of 500 to 1000 gauss. While magnetic field strengths above this range may still be effective, it is believed that the additional cost for such stronger magnets is not justified by a corresponding increase in effectiveness. As an example, and not to limit the scope of the invention, the magnets 30 may be ferrite, rare-earth, or man-made ceramic magnets which have high field strength characteristics and greater resistance to demagnetization as compared to traditional types of magnets.

Still referring to FIGS. 1-3, the collar 10 comprises a length of an outer strap 12 and a length of a padded layer 14 provided on one side of the strap 12. The outer strap 12 and the padded layer 14 may be fastened together by stitching, or by any other suitable means. By way of example, and not to restrict the scope of the invention, the outer strap 12 may be of woven nylon material to provide strength and resistance to wear. The outer strap can also be made from leather or a combination of suitable materials, such as, for example, leather and nylon. The padded layer 14 may be made of felt or cotton, or any similar material to provide a soft layer for the pet's comfort. Stitching has been found to be a cost effective way of fastening these materials together.

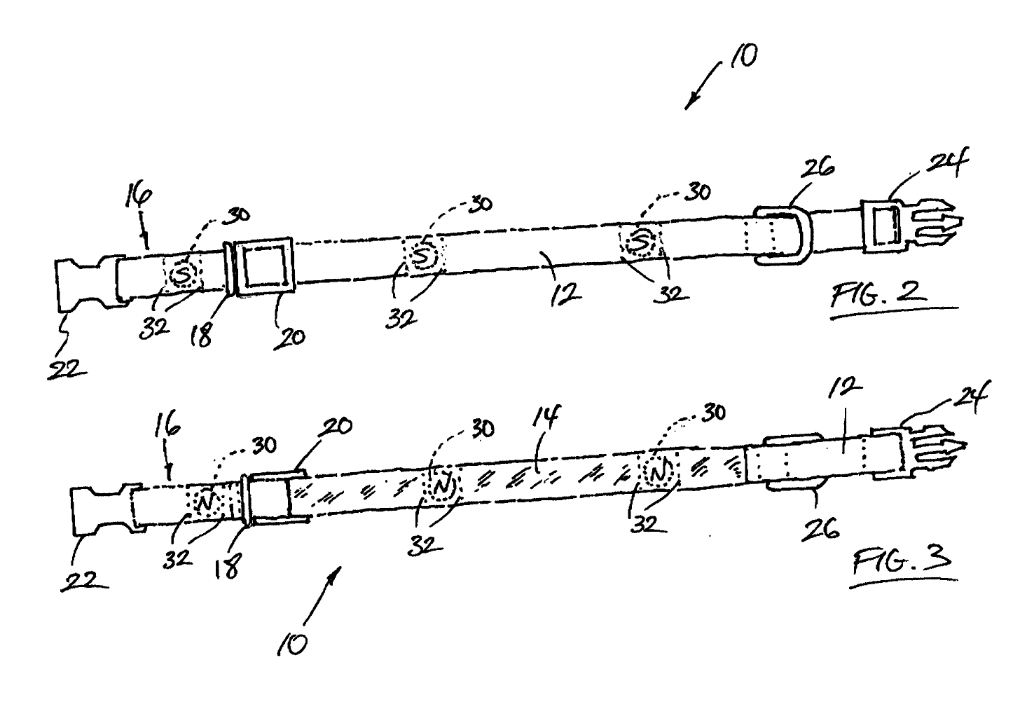

As explained above, the magnets 30 are distributed at intervals along the length of the collar 10. In the preferred embodiment shown in FIGS. 1-3, each magnet 30 is fitted between the outer strap 12 and the padded layer 14, and stitched into position so that the magnet 30 is fixed in position and orientation (i.e., the orientation of the north pole towards the animal). As shown in FIGS. 2 and 3, the magnets 30 are distributed at intervals such that when the collar 10 is worn around the neck of a pet, the magnets 30 will form a triangle around the neck of the pet. Three magnets 30 are shown in the preferred embodiment by way of example only, and it is not intended that the apparatus of the present invention be limited in the number of magnets 30. Rather, it has been found that three magnets 30 arranged in the manner shown are sufficient for the intended purpose of the present invention.

Still referring to FIGS. 1-3, the collar 10 may be length-adjustable and include a releasable fastener adapted to releasably join each end of the collar 10 together. In the preferred embodiment, the releasable fastener comprises a two-piece interlocking plastic buckle 22, 24. At least one of the pieces 22 is adapted to slidably receive a looped end 16 of the collar 10. In known manner, by threading a short length of the loop 16 through a loop buckle 20, the size of the loop 16 can be adjusted to facilitate the length-adjustment of the collar 10. A sliding ring 18 is provided to hold the looped end 16 together. Optionally, to connect the collar 10 to a leash (not shown), a second fixed ring 26 is shown.

In use the collar embodiment of the invention is placed around the neck of the pet. In tests conducted under the direction of the inventor using a collar embodiment of the present invention, a noticeable reduction in shedding was prevalent.

Although the invention has been described and illustrated with reference to a preferred embodiment, those skilled in the art will appreciate that the invention may be otherwise embodied within the scope of the following claims.

I claim:

1. An apparatus for reducing shedding in pets, said apparatus comprising:
a collar of a suitable length to fit around the neck of a pet; and
at least one magnet fitted on said collar;
wherein each of said at least one magnets has its north pole directed towards the neck of the pet, and the magnetic field produced is sufficient to reduce shedding in pets.

2. The apparatus as claimed in claim 1, wherein the collar comprises a length of an outer strap, and a length of a padded layer provided on one side of said outer strap forming an inner surface of the collar, said at least one magnet being fitted between said outer strap and said padded layer.

3. The apparatus as claimed in claim 2, wherein there are a plurality of said magnets, and said magnets are distributed at intervals along the length said collar.

4. The apparatus as claimed in claim 2, wherein there are three of said magnets, and said magnets are distributed at intervals along said collar to form a triangle when said collar is worn around the neck of a pet.

5. The apparatus as claimed in claim 2, wherein said outer strap and said padded layer are fastened together by stitching, and each of said magnets is retained in position by stitching.

6. The apparatus as claimed in claim 5, wherein said collar is length-adjustable and includes a releasable fastener adapted to releasably join each end of said collar.

7. The apparatus as claimed in claim 6, wherein said releasable fastener comprises a two-piece interlocking plastic buckle, at least one said pieces being adapted to slidably receive one looped end of said collar, said loop being adjustable in size to facilitate said length-adjustment of the collar.

8. The apparatus as claimed in claim 5, wherein said outer strap comprises a nylon strap and said padded layer is one of felt and cotton.

9. The apparatus as claimed in claim 5, wherein the outer strap is made from leather.

10. The apparatus as claimed in claim 3, wherein said outer strap and said padded layer are joined together by stitching, and said at least one magnet is retained in position by said stitching.

11. The apparatus as claimed in claim 10, wherein said collar is length-adjustable and includes a releasable fastener adapted to releasably fasten together each end of said collar.

12. The apparatus as claimed in claim 11, wherein said releasable fastener comprises a two-piece interlocking plastic buckle, at least one said pieces being adapted to slidably receive one looped end of said collar, said loop being adjustable in size to facilitate said length-adjustment of the collar.

13. The apparatus as claimed in claim 10, wherein said outer strap comprises a nylon strap and said padded layer is one of felt and cotton.

14. The apparatus as claimed in claim 10, wherein the outer strap is made from leather.

15. The apparatus according to claim 1 wherein each of said at least one magnets has a magnetic field strength in the range of 500 to 1000 gauss.

16. The apparatus according to claim 2 wherein each of said at least one magnets has a magnetic field strength in the range of 500 to 1000 gauss.

17. The apparatus according to claim 3 wherein each of said at least one magnets has a magnetic field strength in the range of 500 to 1000 gauss.

18. The use of a magnetic field to reduce shedding in a pet, said magnetic field being provided by positioning at least one magnet around the neck of the pet and having its north pole oriented towards the neck of the pet, wherein said at least one magnet produces a magnetic field sufficient to reduce shedding in pets.

19. The use claimed in claim 18 wherein each of said at least one magnets has a magnetic field strength in the range of 500 to 1000 gauss.

20. The use claimed in claim 19, wherein, said pet is one of a dog and a cat.
